(19) United States
(12) Patent Application Publication
(10) Pub. No.: US 2024/0201959 A1
(43) Pub. Date: Jun. 20, 2024

(54) MACHINE LEARNING STRUCTURED RESULT GENERATION

(71) Applicant: Microsoft Technology Licensing, LLC, Redmond, WA (US)

(72) Inventors: Shawn Cantin CALLEGARI, Bellevue, WA (US); Abby HARRISON, Woodinville, WA (US); Umesh MADAN, Bellevue, WA (US); LeRoy F. MILLER, Tacoma, WA (US); Brian KRABACH, Snohomish, WA (US); Devis LUCATO, Kirkland, WA (US); Alexander CHAO, Irvine, CA (US); Mark KARLE, Seattle, WA (US); Gina Elizabeth TRIOLO, Redmond, WA (US); Tara Eve WALKER, Atlanta, GA (US); Nicholas BECKER, Boulder, CO (US)

(73) Assignee: Microsoft Technology Licensing, LLC, Redmond, WA (US)

(21) Appl. No.: 18/129,668

(22) Filed: Mar. 31, 2023

Related U.S. Application Data
(60) Provisional application No. 63/441,974, filed on Jan. 30, 2023.
(60) Provisional application No. 63/433,627, filed on Dec. 19, 2022.

(51) Int. Cl. G06F 8/35

(52) U.S. Cl. CPC G06F 8/35

(57) ABSTRACT

Aspects of the present application relate to machine learning (ML) structured result generation. In examples, an instruction of programmatic code that invokes an ML model indicates a result interface in which model output is to be stored. The result interface is processed to generate a data format description for the result interface, such that the input to the ML model further includes the data format description. As a result of providing the data format description as input to the ML model, the ML model is induced to generate structured model output that corresponds to the result interface. The resulting model output is processed to generate an instance of the result interface, for example having one or more corresponding properties from the structured model output. Accordingly, the programmatic code is able to reliably perform subsequent processing based on the generated instance of the result interface.

### CROSS-REFERENCE TO RELATED APPLICATIONS

This application claims priority to U.S. Provisional Application No. 63/441,974, titled “Machine Learning Structured Result Generation,” filed on Jan. 30, 2023, and U.S. Provisional Application No. 63/433,627, titled “Multi-Stage Machine Learning Model Chaining,” filed on Dec. 19, 2022, the entire disclosures of which are hereby incorporated by reference in their entirety.

### BACKGROUND

Output generated by a machine learning (ML) model may have some degree of variability, such that incorporating ML processing into programmatic code is challenging. For example, the ML model may generate output including different terminology and/or having a different structure. These and other variations in ML model output may thus result in unexpected or unintended behavior of the programmatic code, or may cause the programmatic code to fail altogether, among other potential detriments.

It is with respect to these and other general considerations that embodiments have been described. Also, although relatively specific problems have been discussed, it should be understood that the embodiments should not be limited to solving the specific problems identified in the background.

### SUMMARY

Aspects of the present application relate to machine learning (ML) structured result generation. In examples, an instruction of programmatic code that invokes an ML model indicates a result interface in which model output is to be stored. The result interface is processed to generate a data format description for the result interface, such that the input to the ML model further includes the data format description. As a result of providing the data format description as input to the ML model, the ML model is induced to generate structured model output that corresponds to the result interface. The resulting model output is processed to generate an instance of the result interface, for example having one or more corresponding properties from the structured model output. Accordingly, the programmatic code is able to reliably perform subsequent processing based on the generated instance of the result interface.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system in which machine learning structured result generation may be used according to aspects of the present disclosure.

FIG. 2 illustrates an overview of an example method for obtaining and processing structured machine learning model output according to aspects described herein.

FIG. 3 illustrates an overview of an example method for generating structured machine learning model output according to aspects described herein.

FIGS. 4A and 4B illustrate overviews of an example generative machine learning model that may be used according to aspects described herein.

FIG. 5 is a block diagram illustrating example physical components of a computing device with which aspects of the disclosure may be practiced.

FIG. 6 is a simplified block diagram of a computing device with which aspects of the present disclosure may be practiced.

FIG. 7 is a simplified block diagram of a distributed computing system in which aspects of the present disclosure may be practiced.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, a machine learning (ML) model produces model output based on an input (e.g., as may be generated or otherwise provided by programmatic code and/or obtained from a user). For example, natural language input is processed using a generative ML model to produce model output accordingly. However, in instances where such a model interaction is included as part of programmatic code, parsing or otherwise processing the model output may be challenging, as output generated by the ML model may not be deterministic or may otherwise have a degree of variability. Such challenges may be in contrast to an application programming interface (API), where the API includes defined functionality that yields output according to a predefined format.

As a result of such unpredictability, the programmatic code may incorporate various pattern matching techniques, data sanitation techniques, and/or any of a variety of other processing to incorporate model output from an ML model into processing that is performed by the programmatic code. Such aspects may increase code complexity and/or development time, while potentially decreasing reliability of the programmatic code, among other detriments. For example, if the programmatic code fails to handle an edge case in which the ML model generates output that is different than what is expected by the programmatic code, the programmatic code may exhibit unexpected/unintended behavior or may fail to operate.

Accordingly, aspects of the present disclosure relate to machine learning structured result generation. In examples, an instruction of programmatic code that invokes an ML model is identified. The identified programmatic instruction may include input to the ML model (or, as another example, may reference previously generated model output of an earlier programmatic instruction), and output of the ML model invocation (e.g., as is generated based on the input and/or previously generated model output) is subsequently processed according to one or more other programmatic instructions of the code.

The programmatic instruction that invokes the ML model (also referred to herein as a “programmatic ML invocation”) may further indicate a result interface in which model output is to be stored. As used herein, a result interface includes, but is not limited to, a primitive datatype (e.g., an integer, a string, or a floating point number) or a complex datatype (e.g., a class, a struct, an array, a map, a dictionary, or a dynamic type), among any of a variety of other data structures. For example, the programmatic code may define a class or other data structure that is a result interface for ML model output. Example programmatic code includes, but is not limited to, source code (e.g., in an interpreted or a compiled language), byte code, and/or machine code, among other examples. As another example, a development environment or library defines one or more result interfaces for use by the programmatic code. As such, the result interface is processed to generate a data format description for the result interface, such that the input to the ML model further includes the data format description according to aspects described herein.

For example, the input to the ML model includes background context, an instruction relating to the programmatic instruction (e.g., at least a part of the programmatic instruction or other representation of the programmatic instruction), a request to generate model output according to a provided data format description, the data format description. and/or an indication to complete the input with subsequently generated model output, among other examples. As a result of providing the data format description as part of the input to the ML model, the ML model is induced to generate structured model output that corresponds to the result interface. The resulting model output is processed to generate an instance of the result interface, for example having one or more corresponding properties from the structured model output. As a result, the programmatic code is able to reliably perform subsequent processing based on the generated instance of the result interface.

As used herein, structured model output includes, but is not limited to, one or more key/value pairs, extensible markup language (XML) output, YAML output, and/or JavaScript object notation (JSON) output, among any of a variety of other structured data formats. In examples, a data format description that is generated for a result interface similarly includes such a structured data format. The generated data format description describes a set of properties of the result interface, where each property of the result interface can itself be a primitive or complex type. For example, the data format description includes a property name, an indication of whether the property is optional, a default value for the property, an indication as to an expected data type/format (e.g., an email address, a phone number, a uniform resource locator (URL), a date, a time, or a datetime), a description of the property, a minimum and/or maximum value for the property, a set of enumerated values for the property, and/or a maximum character and/or list length for the property, among any of a variety of additional or alternative property attributes. In examples, a minimum/maximum length attribute is converted to a maximum/minimum token length, which may improve accuracy of the ML model when generating structured output corresponding to such an attribute.

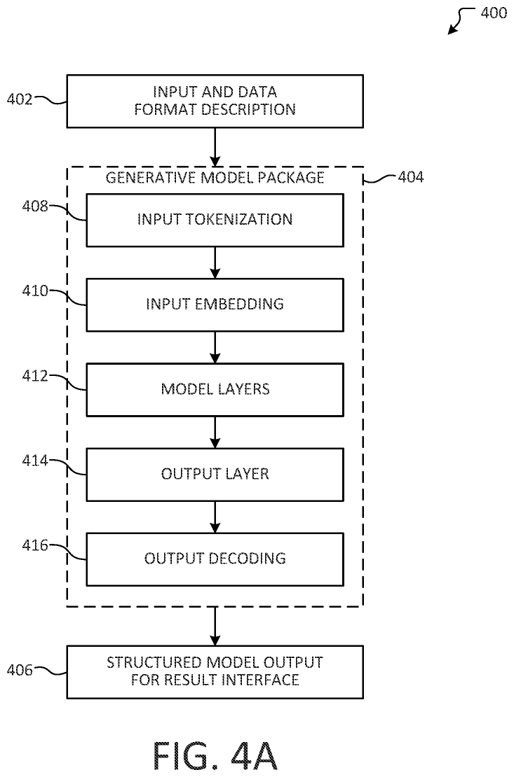

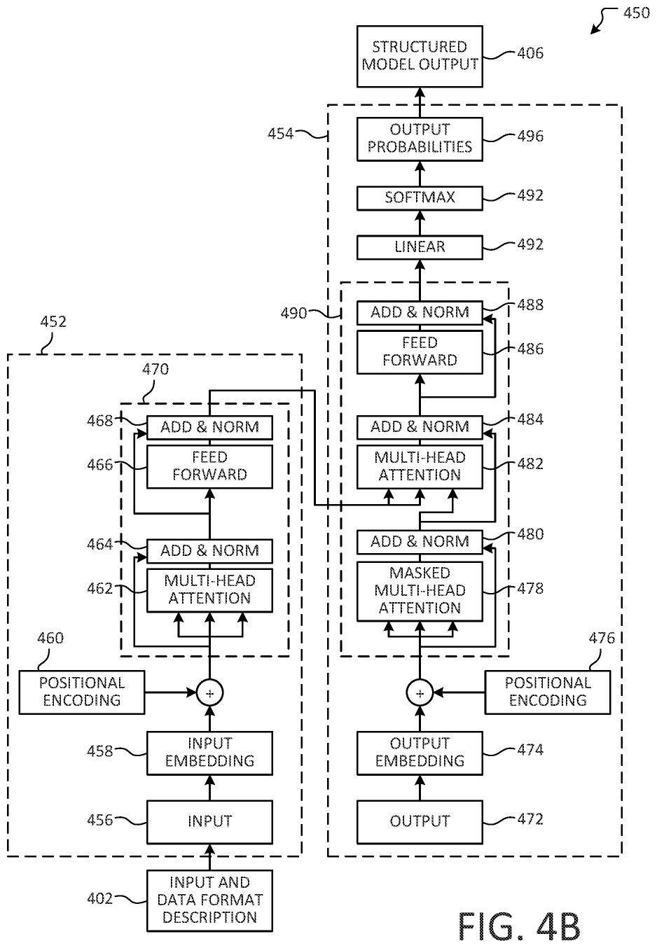

A generative model (also generally referred to herein as a type of ML model) used according to aspects described herein may generate any of a variety of output types (and may thus be a multimodal generative model, in some examples) and may be a generative transformer model and/or a large language model (LLM), a generative image model, in some examples. Example ML models include, but are not limited to, Generative Pre-trained Transformer 3 (GPT-3), BigScience BLOOM (Large Open-science Open-access Multilingual Language Model), DALL-E, DALL-E 2, Stable Diffusion, or Jukebox. Additional examples of such aspects are discussed below with respect to the generative ML model illustrated in FIGS. 4A-4B.

It will be appreciated that any of a variety of techniques may be used to generate a data format description for a result interface according to aspects described herein. For example, programmatic code that defines the result interface is processed to generate a schema corresponding to the result interface, which may thus form a part of the data format description accordingly. The data format description may further include an instruction to generate model output in adherence to the raw schema. Using such a raw schema to describe the result interface may improve model output generation accuracy, as the ML model is provided with an accurate, complete, and/or verbose definition of the result interface with which to generate the model output accordingly. However, use of a raw schema to describe a result interface may consume a larger number of available tokens for a given ML model (as compared to other example aspects described herein), thereby limiting other input that can be provided and/or output that can be generated by the ML model.

As another example, the data format description for a result interface includes example structured output corresponding to the result interface, such that model output generated by an ML model follows the example structured output. For instance, the example structured output may be obtained from previous ML processing associated with the reference interface, may be specified by a developer of the programmatic code, and/or may be a serialized representation of one or more instances of the result interface (e.g., as may have been defined by a developer), among other examples. In some examples, the example structured output further includes one or more comments that describe aspects of the result interface instance. The data format description may further include an instruction to generate model output following the included example format(s) (e.g., as well-formed XML/YAML/JSON output). As compared to a raw schema, the example structured output may consume less of the available tokens for a given ML model. However, the example structured output may include less detail (e.g., an optional property may not be included in the example structured output or an indication may not be included that a defined property is otherwise optional), thereby resulting in lower quality structured output from the ML model.

As a further example, the data format description for a result interface includes a summary representation of the raw schema. For example, the summary representation is generated based on the raw schema, where the summary representation is structured according to the format in which the structured output is to be generated. In examples, one or more properties of the result interface are included as a string, where each string includes a type for the corresponding property, a property description, whether the property is nullable, whether the property has a default value, and/or associated constraints, among other property attributes. The data format description may further include an instruction to generate model output in adherence to the summary representation accordingly. Thus, the summary representation includes similar information about the result interface (and, in some examples, more information that would be included in instances where example structured output is used), while consuming a reduced amount of tokens for processing by the ML model.

It will therefore be appreciated that any of a variety of techniques may be used to generate a data format description according to aspects described herein. As another example, a representation of a result interface may be provided as input to an ML model (e.g., with an instruction to summarize or otherwise describe the result interface), where the ML model generates a data format description for the result interface accordingly. The resulting model output may be cached for future use. Even so, use of an ML-generated data format description may incur additional processing overhead (e.g., as a result of the associated ML processing) as compared to other example data format description generation techniques.

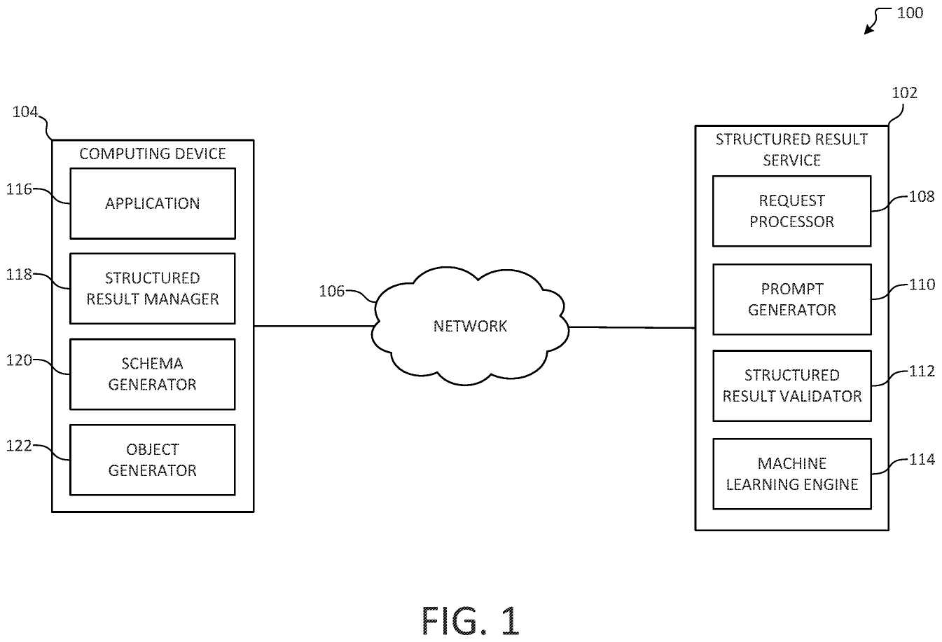

FIG. 1 illustrates an overview of an example system 100 in which machine learning structured result generation may be used according to aspects of the present disclosure. As illustrated, system 100 includes structured result service 102, computing device 104, and network 106. In examples, structured result service 102 and computing device 104 communicate via network 106, which may comprise a local area network, a wireless network, or the Internet, or any combination thereof, among other examples.

As illustrated, computing device 104 includes application 116, structured result manager 118, schema generator 120, and object generator 122. In examples, application 116 includes programmatic code that invokes a machine learning model (e.g., of machine learning engine 114). Accordingly, structured result manager 118 may identify such a programmatic ML invocation of application 116, which may indicate a result interface in which model output is to be stored. For example, the programmatic ML invocation may be identified as a result of executing or otherwise processing the programmatic instruction.

Accordingly, schema generator 120 processes the result interface to generate a schema. As noted above, the result interface may be a primitive type or a complex type, and the generated schema may therefore indicate one or more properties of the result interface, as well as one or more attributes associated with each of the properties. While computing device 104 is illustrated as comprising schema generator 120, it will be appreciated that any of a variety of other techniques may be used to generate a schema. Further, while system 100 is illustrated as an example in which a data format description is generated based on a schema for the result interface, it will be appreciated that, in other examples, a schema need not be generated and the data format description may be generated or otherwise obtained according to any of a variety of other techniques. For instance, application 116 may instead include example structured output that is used in addition to or as an alternative to other aspects of a data format description.

In examples, at least some aspects described herein may be performed prior to execution of application 116. For instance, a schema and/or an associated data format description may be pre-generated (e.g., at compile time or as a preprocessing step), such that the schema and/or associated data format description is available for subsequent processing according to aspects described herein.

Structured result manager 118 provides an indication of the generated schema to structured result service 102. In examples, the indication further includes input that was specified by application 116 (e.g., as may have been generated by application 116 and/or obtained from a user of computing device 104, among other examples). In other examples, the indication references previously generated model output, as may be the case when a previous programmatic instruction of application 116 generated model output that a subsequent programmatic instruction is processing to generate an instance of a result interface according to aspects described herein.

As illustrated, structured result service 102 includes request processor 108, prompt generator 110, structured result validator 112, and machine learning engine 114. In examples, request processor 108 receives an ML processing request from computing device 104 (e.g., comprising an indication of a schema and/or input for processing by an ML model, as may have been generated by schema generator 120 and application 116, respectively).

Accordingly, an indication of the request is provided to prompt generator 110, which generates a prompt for an ML model of machine learning engine 114. In examples, the generated prompt includes the input that was received from computing device 104 (or, as another example, a reference to previously generated model output) and a data format description according to aspects described herein. For example, prompt generator 110 processes a schema that was received from computing device 104 to generate a summary representation of the schema, which is then used as part of the data format description accordingly. As another example, the schema is used as part of the data format description. As a further example, prompt generator 110 provides an indication of the schema to an ML model of machine learning engine 114 (e.g., in conjunction with a prompt requesting generation of a data format description), such that model output that is received in response is used as part of the data format description accordingly.

An example of a prompt that may be generated by prompt generator 110 is provided below for reference:
/// BEGIN PROMPT
input content>

Results are in well-formed <JSON/XMIL> format and adhere strictly to the format below.
<example structured output, raw schema, or summary schema, among other examples>
/// END PROMPT

Thus, the generated prompt includes the received input, an indication of a structured data format (e.g., JSON or XML, in the instant example), and the data format description for the result interface of application 116. The generated prompt is processed by machine learning engine 114 to generate structured model output accordingly. While structured result service 102 is illustrated as including machine learning engine 114, it will be appreciated that a third-party or remote machine learning service may additionally or alternatively be used in other examples.

In examples, an ML model is selected from a set of ML models, as may be the case when the prompt is associated with a given ML model. As another example, the request received by request processor 108 includes an indication of a specific ML model with which to process the input. In some instances, structured result service 102 determines to generate multiple ML interactions (e.g., each having an associated prompt and a resulting model output). For example, structured result service 102 may determine that an ML processing request (e.g., as may have been received from computing device 104) would exceed a token limit of an associated ML model, such that structured result service 102 generates multiple prompts, each of which include at least a part of the input. Structured result service 102 may then generate an additional prompt to combine the resulting set of model outputs, which, for example, may include a data format description, thereby causing the ML model to generate structured output based on the set of model outputs accordingly. In other examples, a first ML interaction may combine the set of model outputs, while a second ML interaction generates the structured output accordingly.

In examples, structured result validator 112 evaluates structured model output from an ML model (e.g., as was generated based on a prompt that includes a data format description), for example to determine whether the structured model output is syntactically correct and/or whether the structured model output conforms to a schema (e.g., as may have been generated by schema generator 120), among other examples. In instances where structured result validator 112 determines the structured model output fails validation, structured result validator 112 may attempt to a remedial action and/or may provide an indication to computing device 104 (e.g., for further handling by application 116 and/or for review of a user of computing device 104). Example remedial actions include, but are not limited to, attempting to correct malformed structured output (e.g., by closing symbols/tags), requesting that an ML model correct the structured output (e.g., providing a prompt to generate structured output that is syntactically correct based on the malformed output and/or to finish generation of the structured output), and/or selecting a different instance of structured model output that was generated by the ML model.

If the structured model output is successfully validated by structured result validator 112, the structured model output is provided to computing device 104 (e.g., in response to the request for model output), such that object generator 122 processes the structured model output to generate an instance of a result interface accordingly. For example, object generator 122 processes the structured model output to instantiate an instance of the result interface that includes one or more properties as defined by the structured model output. It will be appreciated that, the format of the structured model output need not be the same as the structure of the result interface. For instance, object generator 122 may process structured model output that is JSON to generate an instance of a result interface that need not be a JSON object.

While examples are described in which a result interface is instantiated, it will be appreciated that similar techniques may be used where the structured model output itself is provided for subsequent processing by programmatic code accordingly. For instance, the programmatic code may process XML/YAML/JSON output as an alternative to or in addition to a generated instance of a result interface according to aspects described herein.

Thus, as a result of providing a schema in conjunction with input for ML processing, structured result service 102 effectively operates as an API for any of a variety of languages and/or data types/formats. That is, structured result service 102 may generate any of a variety of structured model output for similar input, where the structured model outputs are structured according to a schema that was provided in conjunction with the request for model output.

As another example, aspects of the present disclosure may be used to cast an object of a first data type to an object of a second data type. For instance, a serialized representation of the object in the first data type may be provided in conjunction with a schema for the second data type, such that structured result service 102 generates structured model output that includes a representation of the object according to the second data type. The structured model output may then be processed (e.g., by object generator 122) to instantiate an object of the second data type accordingly (e.g., that includes properties as indicated by the structured model output).

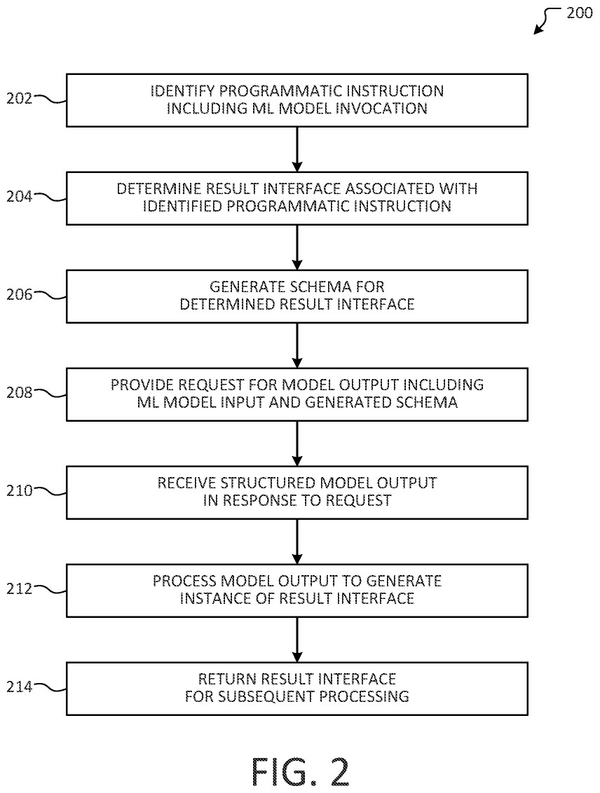

FIG. 2 illustrates an overview of an example method 200 for obtaining and processing structured machine learning model output according to aspects described herein. In examples, aspects of method 200 are performed by a computing device, such as computing device 104 in FIG. 1.

As illustrated, method 200 begins at operation 202, where a programmatic instruction (e.g., of an application, such as application 116 in FIG. 1) that includes an ML model invocation is identified. Aspects of operation 202 may be performed by a structured result manager, such as structured result manager 118 in FIG. 1. For example, the programmatic instruction is identified as a result of executing or otherwise processing programmatic code.

At operation 204, a result interface associated with the identified programmatic instruction is determined. Aspects of operation 204 may be performed by a structured result manager, such as structured result manager 118 in FIG. 1. In examples, the result interface is determined based on an indication of the programmatic instruction that model output generated as a result of the ML model invocation is to be stored using the result interface.

Accordingly, at operation 206, a schema is generated for the determined result interface. In examples, aspects of operation 206 are performed by a schema generator, such as schema generator 120 in FIG. 1. For example, operation 206 comprises evaluating a definition of the result interface to generate the schema, such that the schema includes an indication of one or more properties of the result interface and, in some examples, one or more corresponding property attributes for each of the properties. In other examples, operation 206 comprises providing an indication of a definition for the resource interface to a schema generation service, such that the schema is received in response. It will therefore be appreciated that any of a variety of techniques may be used to generate a schema according to aspects described herein. Further, it will be appreciated that method 200 is described in an example where the data format description is generated by a structured result service and that, in other examples, such aspects may additionally or alternatively be performed at operation 206.

Flow progresses to operation 208, where a request for ML model output is provided, where the request includes the generated schema. In examples, the request further includes input for processing by the ML model and/or an indication as to previously generated model output, among other examples. As an example, the request is provided to a structured result service, such as structured result service 102 in FIG. 1. In some examples, the request includes an indication as to an ML model with which the input is to be processed.

At operation 210, structured model output is received in response to the request that was provided at operation 208. In examples, the structured model output includes data that is formatted according to one or more structured data formats, including, but not limited to, XML, YAML, and/or JSON, among other examples.

Method 200 progresses to operation 212, where the structured model output is processed to generate an instance of the result interface accordingly. In examples, aspects of operation 212 are performed by an object generator, such as object generator 122 in FIG. 1. For example, the instantiated resource interface includes one or more properties that are defined as specified by the structured model output that was received at operation 210. It was noted above with respect to FIG. 1 that a structured result service may validate structured model output prior to providing structured output in response to a request for ML processing. In some examples, such validation and/or remedial actions may additionally or alternatively be performed as part of operation 212.

Moving to operation 214, the instance of the result interface that was generated at operation 212 is returned for subsequent processing (e.g., by one or more other instructions of the programmatic code, such as application 116 in FIG. 1) according to aspects described herein. For example, the programmatic code may access one or more properties of the instantiated result interface, such that a value associated therewith is used for subsequent processing. Such aspects may be in contrast to data extraction and/or pattern recognition that may alternately be performed in instances where ML model output is not structured according to aspects described herein. Method 200 is provided in an example where the structured model output is used to instantiate a result interface, though it will be appreciated that similar techniques may be used in instances where the structured model output itself (e.g., as was received at operation 210) is additionally or alternatively processed. Method 200 terminates at operation 214.

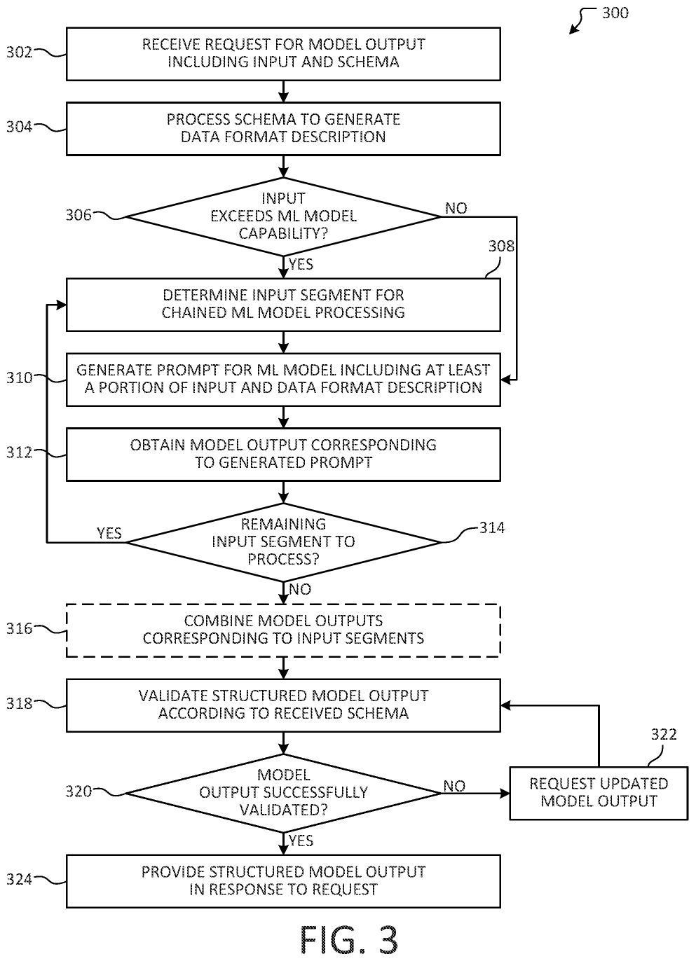

FIG. 3 illustrates an overview of an example method 300 for generating structured machine learning model output according to aspects described herein. In examples, aspects of method 300 are performed by a structured result service, such as structured result service 102 in FIG. 1.

As illustrated, method 300 begins at operation 302, where an ML processing request is received that includes an indication of input and a schema. In examples, the request is received by a request processor (e.g., request processor 108 in FIG. 1) from a structured result manager (e.g., structured result manager 118). The request may have been generated as a result of a computing device performing aspects of operation 208 discussed above with respect to method 200 of FIG. 2. As noted above, the request may include input for ML processing and/or may reference previously generated model output, among other examples. The schema that is received as part of the request may have been generated by a schema generator, such as schema generator 120 in FIG. 1.

Method 300 progresses to operation 304, where the schema is processed to generate a data format description. In examples, aspects of operation 304 are performed by a prompt generator, such as prompt generator 110 in FIG. 1. In examples, the generated data format description includes the schema that was received at operation 302 (e.g., as a raw schema), includes generating a summary representation of the schema, or includes processing the schema using an ML model to generate the data format description accordingly. In other examples, the received request instead includes example structured output, such that operation 304 may be omitted.

Flow progresses to determination 306, where it is determined whether the input exceeds one or more capabilities of the ML model. For example, determination 306 comprises evaluating a number of tokens consumed by the input and/or a number of tokens that are available for the structured model output. If it is determined that the input does not exceed an ML model capability, flow branches “NO” to operation 310, which is described below.

However, in instances where a number of tokens is below a predetermined threshold, flow branches “YES” to operation 308, where an input segment is determined for chained ML processing, such that the input is processed according to a set of ML evaluations that are chained together. In examples, determining the input segment comprises selecting a subpart of the input, such that one or more other subparts are processed in subsequent iterations of operations 308, 310, 312, and 314. In other examples, the input segment is determined as a result of processing the input to identify one or more skills with which to process the input. It will therefore be appreciated that any of a variety of techniques may be used to generate a plurality of input segments with which to perform chained ML model processing according to aspects described herein.

At operation 310, a prompt is generated for processing by the ML model that includes at least a portion of the input (e.g., according to the determined input segment, in some examples) and the data format description that was generated at operation 304. Aspects of operation 310 may be performed by a prompt generator, such as prompt generator 110 discussed above with respect to FIG. 1. In instances where it is determined to perform chained ML processing, operation 310 may not include the data format description, such that the data format description may instead be included at operation 316 when combining multiple model outputs as discussed in greater detail below.

Flow progresses to operation 312, where model output corresponding to the generated prompt is obtained. For example, the prompt is provided for processing by an ML model (e.g., by a machine learning engine, such as machine learning engine 114 in FIG. 1). Accordingly, the ML model generates model output in response. Additional examples of such aspects are discussed below with respect to FIGS. 4A and 4B. In instances where the prompt includes a data format description, the ML model generates structured model output according to aspects described herein.

Method 300 progresses to determination 314, where it is determined whether there are any remaining input segments to process. Accordingly, if it is determined to process one or more additional input segments, method 300 branches “YES” and returns to operation 308, where an additional input segment is processed according to the above-described operations. Thus, method 300 may loop between operations 308, 310, 312, and 314 to perform chained ML processing of the received input in instances where the ML model processing would exceed one or more capabilities of the ML model.

Eventually, flow may branch “NO” to operation 316, where a set of model outputs (e.g., as were obtained as a result of multiple iterations of operation 312) are combined into a single model output. In examples, operation 316 comprises concatenating, appending, or otherwise combining each model output of the set of model outputs to yield the single model output. For instance, if each model output is a structured model output, the structure of the model output may facilitate combining the model outputs accordingly (e.g., by including properties, tags, or other subparts of the model output into the single model output). Additionally, or alternatively, the set of model outputs are processed by an ML model, for example in combination with the data format description that was generated at operation 304, such that the ML model generates structured model output accordingly. It will therefore be appreciated that any of a variety of techniques may be used to combine a set of model outputs according to aspects described herein. Operation 316 is illustrated using a dashed box to indicate that, in some examples (e.g., in instances where it is determined that the input does not exceed the ML model capability at determination 306), operation 316 may be omitted. In such an example, flow instead progresses from determination 314 to operation 318.

At operation 318, the structured model output is validated. Aspects of operation 318 may be performed by a structured result validator, such as structured result validator 112 in FIG. 1. In examples, operation 318 comprises processing the model output to determine whether it is syntactically correct and/or whether the structured model output conforms to a schema (e.g., as was received at operation 302), among other examples. It will be appreciated that any of a variety of additional or alternative evaluations may be performed in other examples.

Flow progresses to determination 320, where it is determined whether the model output was validated successfully. If it is determined that the output was not successfully validated, flow branches “NO” to operation 322, where updated model output is requested. For example, aspects of operations 306, 308, 310, 312, and/or 314 may be performed to generate one or more additional instances of model output. In some instances, additional or different input may be requested (e.g., from a computing device) as part of operation 322. In other examples, operation 322 comprises evaluating one or more other model outputs that were generated as a result of performing the aspects of method 300 described above, as may be the case when the ML model(s) generate multiple outputs (e.g., each having an associated confidence score and/or ranking).

While method 300 is illustrated in an example where the remedial action of requesting updated model output is performed, it will be appreciated that any of a variety of alternative or additional remedial actions may be performed in other examples. For example, operation 322 may alternatively or additionally comprise attempting to correct malformed structured output and/or requesting that an ML model correct the structured output, among other examples.

Returning to determination 320, if it is instead determined that the structured model output is successfully validated, flow branches “YES’ to operation 320, where the structured model output is provided in response to the request that was received at operation 302. For example, the structured model output is provided to a computing device (e.g., performing aspects of method 200 in FIG. 2), such that the computing device generates an instance of a result interface based on the structured output (e.g., according to aspects of operations 210 and 212). It will be appreciated that the structured output may be provided for any of a variety of alternative or additional processing, for example where programmatic code processes the structured output itself rather than an object that is instantiated based on the structured output. Method 300 terminates at operation 324.

FIGS. 4A and 4B illustrate overviews of an example generative machine learning model that may be used according to aspects described herein. With reference first to FIG. 4A, conceptual diagram 400 depicts an overview of pre-trained generative model package 404 that processes an input and a data format description 402 to generate structured model output 406 for a result interface according to aspects described herein. Examples of pre-trained generative model package 404 includes, but is not limited to, Megatron-Turing Natural Language Generation model (MT-NLG), Generative Pre-trained Transformer 3 (GPT-3), Generative Pre-trained Transformer 4 (GPT-4), BigScience BLOOM (Large Open-science Open-access Multilingual Language Model), DALL-E, DALL-E 2, Stable Diffusion, or Jukebox.

In examples, generative model package 404 is pre-trained according to a variety of inputs (e.g., a variety of human languages, a variety of programming languages, and/or a variety of content types) and therefore need not be finetuned or trained for a specific scenario. Rather, generative model package 404 may be more generally pre-trained, such that input 402 includes a prompt that is generated, selected, or otherwise engineered to induce generative model package 404 to produce certain generative model output 406. For example, a prompt includes a context and/or one or more completion prefixes that thus preload generative model package 404 accordingly. As a result, generative model package 404 is induced to generate output based on the prompt that includes a predicted sequence of tokens (e.g., up to a token limit of generative model package 404) relating to the prompt. In examples, the predicted sequence of tokens is further processed (e.g., by output decoding 416) to yield output 406. For instance, each token is processed to identify a corresponding word, word fragment, or other content that forms at least a part of output 406. It will be appreciated that input 402 and generative model output 406 may each include any of a variety of content types, including, but not limited to, text output, image output, audio output, video output, programmatic output, and/or binary output, among other examples. In examples, input 402 and generative model output 406 may have different content types, as may be the case when generative model package 404 includes a generative multimodal machine learning model.

As such, generative model package 404 may be used in any of a variety of scenarios and, further, a different generative model package may be used in place of generative model package 404 without substantially modifying other associated aspects (e.g., similar to those described herein with respect to FIGS. 1, 2, and 3). Accordingly, generative model package 404 operates as a tool with which machine learning processing is performed, in which certain inputs 402 to generative model package 404 are programmatically generated or otherwise determined, thereby causing generative model package 404 to produce model output 406 that may subsequently be used for further processing.

Generative model package 404 may be provided or otherwise used according to any of a variety of paradigms. For example, generative model package 404 may be used local to a computing device (e.g., computing device 104 in FIG. 1) or may be accessed remotely from a machine learning service (e.g., structured result service 102). In other examples, aspects of generative model package 404 are distributed across multiple computing devices. In some instances, generative model package 404 is accessible via an application programming interface (API), as may be provided by an operating system of the computing device and/or by the machine learning service, among other examples.

With reference now to the illustrated aspects of generative model package 404, generative model package 404 includes input tokenization 408, input embedding 410, model layers 412, output layer 414, and output decoding 416. In examples, input tokenization 408 processes input 402 to generate input embedding 410, which includes a sequence of symbol representations that corresponds to input 402. Accordingly, input embedding 410 is processed by model layers 412, output layer 414, and output decoding 416 to produce model output 406. An example architecture corresponding to generative model package 404 is depicted in FIG. 4B, which is discussed below in further detail. Even so, it will be appreciated that the architectures that are illustrated and described herein are not to be taken in a limiting sense and, in other examples, any of a variety of other architectures may be used.

FIG. 4B is a conceptual diagram that depicts an example architecture 450 of a pre-trained generative machine learning model that may be used according to aspects described herein. As noted above, any of a variety of alternative architectures and corresponding ML models may be used in other examples without departing from the aspects described herein.

As illustrated, architecture 450 processes input 402 to produce generative model output 406, aspects of which were discussed above with respect to FIG. 4A. Architecture 450 is depicted as a transformer model that includes encoder 452 and decoder 454. Encoder 452 processes input embedding 458 (aspects of which may be similar to input embedding 410 in FIG. 4A), which includes a sequence of symbol representations that corresponds to input 456. In examples, input 456 includes input and data format description 402 corresponding to a result interface in which model output is to be stored, as may have been generated by schema generator 120 and/or prompt generator 110 in FIG. 1, for example by performing aspects of operations 202-206 and/or operations 302-304 in FIGS. 2 and 3, respectively.

Further, positional encoding 460 may introduce information about the relative and/or absolute position for tokens of input embedding 458. Similarly, output embedding 474 includes a sequence of symbol representations that correspond to output 472, while positional encoding 476 may similarly introduce information about the relative and/or absolute position for tokens of output embedding 474.

As illustrated, encoder 452 includes example layer 470. It will be appreciated that any number of such layers may be used, and that the depicted architecture is simplified for illustrative purposes. Example layer 470 includes two sub-layers: multi-head attention layer 462 and feed forward layer 466. In examples, a residual connection is included around each layer 462, 466, after which normalization layers 464 and 468, respectively, are included.

Decoder 454 includes example layer 490. Similar to encoder 452, any number of such layers may be used in other examples, and the depicted architecture of decoder 454 is simplified for illustrative purposes. As illustrated, example layer 490 includes three sub-layers: masked multi-head attention layer 478, multi-head attention layer 482, and feed forward layer 486. Aspects of multi-head attention layer 482 and feed forward layer 486 may be similar to those discussed above with respect to multi-head attention layer 462 and feed forward layer 466, respectively.

Additionally, masked multi-head attention layer 478 performs multi-head attention over the output of encoder 452 (e.g., output 472). In examples, masked multi-head attention layer 478 prevents positions from attending to subsequent positions. Such masking, combined with offsetting the embeddings (e.g., by one position, as illustrated by multi-head attention layer 482), may ensure that a prediction for a given position depends on known output for one or more positions that are less than the given position. As illustrated, residual connections are also included around layers 478, 482, and 486, after which normalization layers 480, 484, and 488, respectively, are included.

Multi-head attention layers 462, 478, and 482 may each linearly project queries, keys, and values using a set of linear projections to a corresponding dimension. Each linear projection may be processed using an attention function (e.g., dot-product or additive attention), thereby yielding n-dimensional output values for each linear projection. The resulting values may be concatenated and once again projected, such that the values are subsequently processed as illustrated in FIG. 4B (e.g., by a corresponding normalization layer 464, 480, or 484).

Feed forward layers 466 and 486 may each be a fully connected feed-forward network, which applies to each position. In examples, feed forward layers 466 and 486 each include a plurality of linear transformations with a rectified linear unit activation in between. In examples, each linear transformation is the same across different positions, while different parameters may be used as compared to other linear transformations of the feed-forward network.

Additionally, aspects of linear transformation 492 may be similar to the linear transformations discussed above with respect to multi-head attention layers 462, 478, and 482, as well as feed forward layers 466 and 486. Softmax 494 may further convert the output of linear transformation 492 to predicted next-token probabilities, as indicated by output probabilities 496. It will be appreciated that the illustrated architecture is provided in as an example and, in other examples, any of a variety of other model architectures may be used in accordance with the disclosed aspects. In some instances, multiple iterations of processing are performed according to the above-described aspects (e.g., using generative model package 404 in FIG. 4A or encoder 452 and decoder 454 in FIG. 4B) to generate a series of output tokens (e.g., words), for example which are then combined to yield a complete sentence (and/or any of a variety of other content). It will be appreciated that other generative models may generate multiple output tokens in a single iteration and may thus use a reduced number of iterations or a single iteration.

Accordingly, output probabilities 496 may thus form structured model output 406 according to aspects described herein, such that the output of the generative ML model (e.g., which may include structured output) is used, for example, processed to generate an instance of a result interface (e.g., similar to aspects of operation 212 of method 200 in FIG. 3). In other examples, structured model output 406 is processed by programmatic code (e.g., in addition to or as an alternative to generating an instance of a result interface as described above).

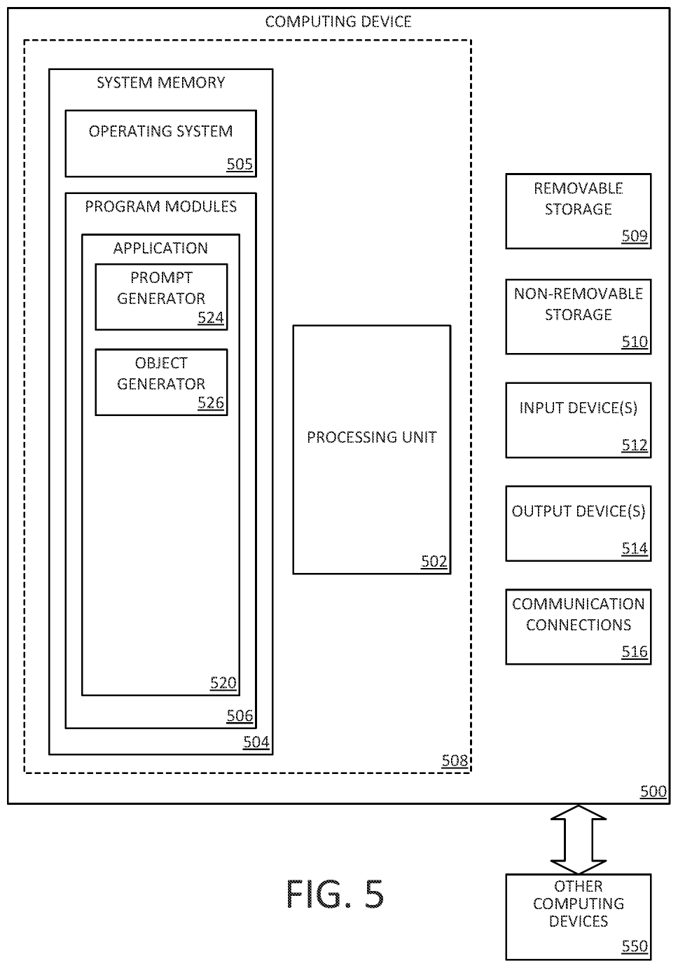

FIGS. 5-7 and the associated descriptions provide a discussion of a variety of operating environments in which aspects of the disclosure may be practiced. However, the devices and systems illustrated and discussed with respect to FIGS. 5-7 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. The computing device components described below may be suitable for the computing devices described above, including one or more devices associated with structured result service 102, as well as computing device 104 discussed above with respect to FIG. 1. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combination of such memories.

The system memory 504 may include an operating system 505 and one or more program modules 506 suitable for running software application 520, such as one or more components supported by the systems described herein. As examples, system memory 504 may prompt generator 524 and object generator 526. The operating system 505, for example, may be suitable for controlling the operation of the computing device 500.

Furthermore, embodiments of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., application 520) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 500 may also have one or more input device(s) 512 such as a keyboard, a mouse, a pen, a sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

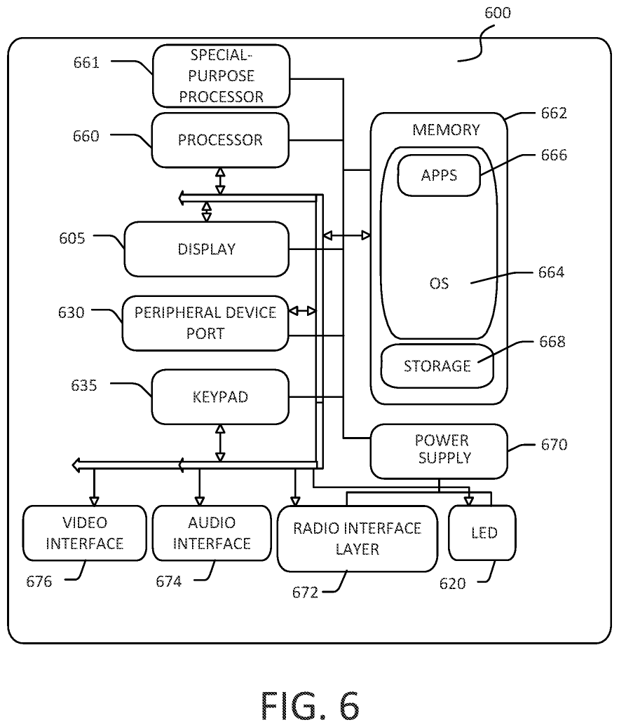

FIG. 6 illustrates a system 600 that may, for example, be a mobile computing device, such as a mobile telephone, a smart phone, wearable computer (such as a smart watch), a tablet computer, a laptop computer, and the like, with which embodiments of the disclosure may be practiced. In one embodiment, the system 600 is implemented as a “smart phone” capable of running one or more applications (e.g., browser, e-mail, calendaring, contact managers, messaging clients, games, and media clients/players). In some aspects, the system 600 is integrated as a computing device, such as an integrated personal digital assistant (PDA) and wireless phone.

In a basic configuration, such a mobile computing device is a handheld computer having both input elements and output elements. The system 600 typically includes a display 605 and one or more input buttons that allow the user to enter information into the system 600. The display 605 may also function as an input device (e.g., a touch screen display).

If included, an optional side input element allows further user input. For example, the side input element may be a rotary switch, a button, or any other type of manual input element. In alternative aspects, system 600 may incorporate more or less input elements. For example, the display 605 may not be a touch screen in some embodiments. In another example, an optional keypad 635 may also be included, which may be a physical keypad or a “soft” keypad generated on the touch screen display.

In various embodiments, the output elements include the display 605 for showing a graphical user interface (GUI), a visual indicator (e.g., a light emitting diode 620), and/or an audio transducer 625 (e.g., a speaker). In some aspects, a vibration transducer is included for providing the user with tactile feedback. In yet another aspect, input and/or output ports are included, such as an audio input (e.g., a microphone jack), an audio output (e.g., a headphone jack), and a video output (e.g., a HDMI port) for sending signals to or receiving signals from an external device.

One or more application programs 666 may be loaded into the memory 662 and run on or in association with the operating system 664. Examples of the application programs include phone dialer programs, e-mail programs, personal information management (PIM) programs, word processing programs, spreadsheet programs, Internet browser programs, messaging programs, and so forth. The system 600 also includes a non-volatile storage area 668 within the memory 662. The non-volatile storage area 668 may be used to store persistent information that should not be lost if the system 600 is powered down. The application programs 666 may use and store information in the non-volatile storage area 668, such as e-mail or other messages used by an e-mail application, and the like. A synchronization application (not shown) also resides on the system 600 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the system 600 described herein.

The system 600 has a power supply 670, which may be implemented as one or more batteries. The power supply 670 might further include an external power source, such as an AC adapter or a powered docking cradle that supplements or recharges the batteries.

The system 600 may also include a radio interface layer 672 that performs the function of transmitting and receiving radio frequency communications. The radio interface layer 672 facilitates wireless connectivity between the system 600 and the “outside world,” via a communications carrier or service provider. Transmissions to and from the radio interface layer 672 are conducted under control of the operating system 664. In other words, communications received by the radio interface layer 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated embodiment, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input, such as to facilitate a telephone conversation. In accordance with embodiments of the present disclosure, the microphone may also serve as an audio sensor to facilitate control of notifications, as will be described below. The system 600 may further include a video interface 676 that enables an operation of an on-board camera 630 to record still images, video stream, and the like.

It will be appreciated that system 600 may have additional features or functionality. For example, system 600 may also include additional data storage devices (removable and/or non-removable) such as, magnetic disks, optical disks, or tape. Such additional storage is illustrated in FIG. 6 by the non-volatile storage area 668.

Data/information generated or captured and stored via the system 600 may be stored locally, as described above, or the data may be stored on any number of storage media that may be accessed by the device via the radio interface layer 672 or via a wired connection between the system 600 and a separate computing device associated with the system 600, for example, a server computer in a distributed computing network, such as the Internet. As should be appreciated, such data/information may be accessed via the radio interface layer 672 or via a distributed computing network. Similarly, such data/information may be readily transferred between computing devices for storage and use according to any of a variety of data/information transfer and storage means, including electronic mail and collaborative data/information sharing systems.

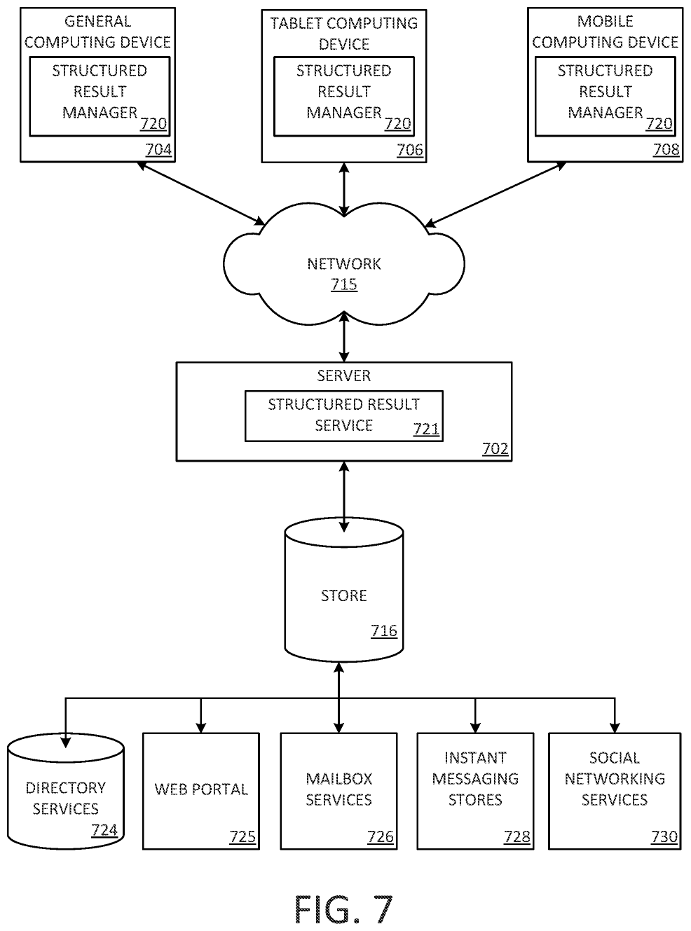

FIG. 7 illustrates one aspect of the architecture of a system for processing data received at a computing system from a remote source, such as a personal computer 704, tablet computing device 706, or mobile computing device 708, as described above. Content displayed at server device 702 may be stored in different communication channels or other storage types. For example, various documents may be stored using a directory service 724, a web portal 725, a mailbox service 726, an instant messaging store 728, or a social networking site 730.

A structured result manager 720 (e.g., similar to the application 520) may be employed by a client that communicates with server device 702. Additionally, or alternatively, structured result service 721 may be employed by server device 702. The server device 702 may provide data to and from a client computing device such as a personal computer 704, a tablet computing device 706 and/or a mobile computing device 708 (e.g., a smart phone) through a network 715. By way of example, the computer system described above may be embodied in a personal computer 704, a tablet computing device 706 and/or a mobile computing device 708 (e.g., a smart phone). Any of these examples of the computing devices may obtain content from the store 716, in addition to receiving graphical data useable to be either pre-processed at a graphic-originating system, or post-processed at a receiving computing system.

It will be appreciated that the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one aspect of the technology relates to a system comprising: at least one processor; and memory storing instructions that, when executed by the at least one processor, cause the system to perform a set of operations. The set of operations comprises: generating a data format description for a result interface of programmatic code, wherein the result interface is defined, by the programmatic code, to receive output of a machine learning model; generating a machine learning (ML) processing request that includes the generated data format description for the result interface; receiving, in response to the ML processing request, structured model output that corresponds to the data format description for the result interface; generating, based on the structured model output, an instance of the result interface; and providing the instance of the result interface for processing by the programmatic code. In an example, generating the instance of the result interface comprises: identifying a property of the structured model output; and populating a corresponding property of the result interface based on a value of the identified property from the structured model output. In another example, the ML processing request is a first ML processing request; and generating the data format description for the result interface comprises: generating a second ML processing request comprising a schema for the result interface; and receiving, in response to the second ML processing request, model output that includes the data format description. In a further example, generating the data format description for the result interface comprises: generating a schema for the result interface; and processing the generated schema to generate the data format description. In yet another example, processing the generated schema to generate the data format description comprises generating a summary representation for the result interface based on the schema. In a further still example, the data format description includes an instruction to generate model output in adherence to the summary representation for the result interface. In another example, the ML processing request further includes a representation of an object of a first type; and the result interface is an object of a second type that is different than the first type. In a further example, the ML processing request includes at least one of: an input to be processed by an ML model associated with the ML processing request; or an indication of previously generated model output.

In another aspect, the technology relates to a method. The method comprises: receiving, from a computing device, a machine learning (ML) processing request that includes a description of a result interface; processing, using an ML model, the ML processing request to generate structured model output according to the description of the result interface; validating the structured model output; and based on determining the structured model output is validated, providing the structured model output in response to the ML processing request. In an example, validating the structured model output comprises at least one of: validating a syntax of the structured model output; or evaluating the structured model output compared to the description of the result interface. In another example, the description of the result interface is a raw schema of the result interface; the method further comprises processing the raw schema to generate a summary representation of the raw schema of the result interface; and the ML processing request is processed according to the generated summary representation for the result interface. In a further example, the ML processing request is a first ML processing request; and the structured model output is a first instance of structured model output; and the method further comprises: receiving a second ML processing request; generating, for the second ML processing request, a second instance of structured model output; validating the second instance of structured model output; and based on determining the second instance of structured model output is not validated, performing a remedial action. In yet another example, the remedial action is at least one of: processing the second instance of structured output to correct malformed syntax of the second instance of structured output; evaluating a secondary output of the ML model that was generated based on the second ML processing request; or providing a request to the ML model to process the second instance of structured output and generate a third instance of structured output.

In a further aspect, the technology relates to another method. The method comprises: generating, as a result of processing a programmatic machine learning (ML) invocation that defines a result interface to receive output of a machine learning model, an ML processing request that includes a description of the result interface and at least one of an input to be processed or an indication of previously generated model output; receiving, in response to the ML processing request, structured model output that corresponds to the description of the result interface; generating, based on the structured model output, an instance of the result interface; and providing the instance of the result interface for processing by the programmatic code. In an example, generating the instance of the result interface comprises: identifying a property of the structured model output; and populating a corresponding property of the result interface based on a value of the identified property from the structured model output. In another example, the ML processing request is a first ML processing request; and the method further comprises: generating a second ML processing request comprising a schema for the result interface; and receiving, in response to the second ML processing request, model output that includes the description of the result interface. In a further example, the method further comprises: generating a schema for the result interface; and processing the generated schema to generate the description of the result interface. In yet another example, processing the generated schema to generate the description comprises generating a summary representation for the result interface based on the schema. In a further still example, the ML processing request includes an instruction to generate model output in adherence to the description of the result interface. In another example, the ML processing request further includes a representation of an object of a first type; and the result interface is an object of a second type that is different than the first type.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
at least one processor; and
memory storing instructions that, when executed by the at least one processor, cause the system to perform a set of operations, the set of operations comprising:
generating a data format description for a result interface of programmatic code, wherein the result interface is defined, by the programmatic code, to receive output of a machine learning model;
generating a machine learning (ML) processing request that includes the generated data format description for the result interface;
receiving, in response to the ML processing request, structured model output that corresponds to the data format description for the result interface;
generating, based on the structured model output, an instance of the result interface; and
providing the instance of the result interface for processing by the programmatic code.

2. The system of claim 1, wherein generating the instance of the result interface comprises:
identifying a property of the structured model output; and
populating a corresponding property of the result interface based on a value of the identified property from the structured model output.

3. The system of claim 1, wherein:
the ML processing request is a first ML processing request; and
generating the data format description for the result interface comprises:
generating a second ML processing request comprising a schema for the result interface; and
receiving, in response to the second ML processing request, model output that includes the data format description.

4. The system of claim 1, wherein generating the data format description for the result interface comprises:
generating a schema for the result interface; and
processing the generated schema to generate the data format description.

5. The system of claim 4, wherein processing the generated schema to generate the data format description comprises generating a summary representation for the result interface based on the schema.

6. The system of claim 5, wherein the data format description includes an instruction to generate model output in adherence to the summary representation for the result interface.

7. The system of claim 1, wherein:
the ML processing request further includes a representation of an object of a first type; and
the result interface is an object of a second type that is different than the first type.

8. The system of claim 1, wherein the ML processing request includes at least one of:
an input to be processed by an ML model associated with the ML processing request; or
an indication of previously generated model output.

9. A method, comprising:
receiving, from a computing device, a machine learning (ML) processing request that includes a description of a result interface;
processing, using an ML model, the ML processing request to generate structured model output according to the description of the result interface;
validating the structured model output; and
based on determining the structured model output is validated, providing the structured model output in response to the ML processing request.

10. The method of claim 9, wherein validating the structured model output comprises at least one of:
validating a syntax of the structured model output; or
evaluating the structured model output compared to the description of the result interface.

11. The method of claim 9, wherein:
the description of the result interface is a raw schema of the result interface;
the method further comprises processing the raw schema to generate a summary representation of the raw schema of the result interface; and
the ML processing request is processed according to the generated summary representation for the result interface.

12. The method of claim 9, wherein:
the ML processing request is a first ML processing request; and
the structured model output is a first instance of structured model output; and
the method further comprises:
receiving a second ML processing request;
generating, for the second ML processing request, a second instance of structured model output;
validating the second instance of structured model output; and
based on determining the second instance of structured model output is not validated, performing a remedial action.

13. The method of claim 12, wherein the remedial action is at least one of:
processing the second instance of structured output to correct malformed syntax of the second instance of structured output;
evaluating a secondary output of the ML model that was generated based on the second ML processing request; or
providing a request to the ML model to process the second instance of structured output and generate a third instance of structured output.

14. A method, comprising:
generating, as a result of processing a programmatic machine learning (ML) invocation that defines a result interface to receive output of a machine learning model, an ML processing request that includes a description of the result interface and at least one of an input to be processed or an indication of previously generated model output;
receiving, in response to the ML processing request, structured model output that corresponds to the description of the result interface;
generating, based on the structured model output, an instance of the result interface; and
providing the instance of the result interface for processing by the programmatic code.

15. The method of claim 14, wherein generating the instance of the result interface comprises:
identifying a property of the structured model output; and
populating a corresponding property of the result interface based on a value of the identified property from the structured model output.

16. The method of claim 14, wherein:
the ML processing request is a first ML processing request; and
the method further comprises:
generating a second ML processing request comprising a schema for the result interface; and
receiving, in response to the second ML processing request, model output that includes the description of the result interface.

17. The method of claim 14, further comprising:
generating a schema for the result interface; and
processing the generated schema to generate the description of the result interface.

18. The method of claim 17, wherein processing the generated schema to generate the description comprises generating a summary representation for the result interface based on the schema.

19. The method of claim 14, wherein the ML processing request includes an instruction to generate model output in adherence to the description of the result interface.

20. The method of claim 14, wherein:
the ML processing request further includes a representation of an object of a first type; and
the result interface is an object of a second type that is different than the first type.
